(19) United States
(12) Patent Application Publication
(10) Pub. No.: US 2020/0394735 A1
(43) Pub. Date: Dec. 17, 2020

(54) PATENT MANAGEMENT SYSTEMS AND METHODS HAVING EXPERT DOCKETING

(71) Applicant: Black Hills IP Holdings, LLC, Minneapolis, MN (US)

(72) Inventor: Steven W. Lundberg, Edina, MN (US)

(21) Appl. No.: 16/911,332

(22) Filed: Jun. 24, 2020

Related U.S. Application Data
(63) Continuation of application No. 14/154,054, filed on Jan. 13, 2014, now abandoned.

(51) Int. Cl. G06Q 50/18; G06Q 10/00

(52) U.S. Cl. CPC G06Q 50/184; G06Q 10/00

(57) ABSTRACT

Methods and systems for managing patent matters are provided. The method comprises receiving docketing information to select a matter for docketing. The method includes accessing at least one previously docketed docketing activity data for the matter; and identifying at least one next most probable docketing activity based on the at least one previously docketed docketing activity data for the matter.

### BACKGROUND

The management of patent portfolios involves multiple stages of the patent lifecycle. Initially, a decision is made as to what inventions are worth the investment of filing a patent application. Then, each filed patent application goes through prosecution with the patent office. Finally, for each patent that is allowed, maintenance fees must be paid at a variety of intervals to keep the patent in force. Patent management tools are used by companies and law firms to active patent matters (e.g., unfiled, pending and issued patent matters) as well as inactive patent matters (e.g., expired, abandoned or closed patent matters) to enable users to efficiently manage patent matters throughout the patent lifecycle. Many patent management tools include patent docketing capabilities for tracking important due dates for PTO related deadlines and providing a document repository for PTO related correspondences and documents. The patent docketing process may involve (1) storing all key intellectual property information in a centralized and consolidated database; (2) providing access to critical information from documents (e.g., correspondences between law firms and the U.S. PTO, or law firms and clients) and deadlines (e.g., PTO deadlines and non-PTO deadlines); and (3) providing customizable workflows for streaming and automating the patent management processes throughout the patent lifecycle.

### BRIEF DESCRIPTION OF DRAWINGS

Some embodiments are illustrated by way of example and not limitation in the figures of the accompanying drawings in which:

FIG. 1 is a system component diagram, according to an example embodiment.

FIG. 2 is a block diagram of a patent management system, according to an example embodiment.

FIG. 3A illustrates a block diagram of a method of docketing based on the next most probable docketing activities, according to an example embodiment.

FIG. 3B illustrates a block diagram of method of docketing based on next most probable docketing activities, according to one embodiment.

FIG. 3C illustrates a block diagram of a method of docketing based on the next most probable docketing activities, according to another example embodiment.

FIG. 3D illustrates a block diagram of a method of verifying docketing activities based on the next most probable docketing activities, according to an example embodiment.

FIG. 4 illustrates a user interface for presenting patent matter details of a matter, according to an example embodiment.

FIG. 5 illustrates a user interface for presenting docketing activities in a patent matter, according to an example embodiment.

FIG. 6 illustrates a user interface for presenting a pull-down menu with options representing the next most probable docketing activities, according to an example embodiment.

FIG. 7A illustrates a user interface for presenting a docketing activity template, according to an example embodiment.

FIG. 7B illustrates a user interface for selecting a docketing activity template within a patent matter, according to example embodiments.

FIG. 7C illustrates a partial list of docketing activity template names and template codes for patent management system, according to an example embodiment.

FIG. 8A illustrates an example of the next most probable docketing activity based on a last docketing activity of application filed docketed in a patent matter, according to one embodiment.

FIG. 8B illustrates an example of the next most probable docketing activity based on a last docketing activity of non-final office action response docketed in a patent matter, according to one embodiment.

FIG. 8C illustrates an example of the next most probable docketing activity based on a last docketing activity of request for continued examination filed docketed in a patent matter, according to one embodiment.

FIG. 9 is a block diagram of machine in the example form of a computer system within which a set of instructions, for causing the machine to perform any one or more of the methodologies herein discussed, may be executed.

### DETAILED DESCRIPTION

The life cycle of a patent may include multiple stages. These stages generally include harvesting and reviewing inventions, filing patent applications on the inventions, prosecuting the patenting applications to allowance or abandonment, determining whether to file any continuing applications, and paying maintenance fees on the issued patents.

Once a patent application is filed, the patent examination process, also referred to as prosecution, is started. During prosecution, a patent examiner will examine the patent application to determine if the requirements of obtaining a patent are met. The communications between the inventor (or assignee, or representative of the inventor or assignee) and the patent examiner during the examination process is commonly referred to as the prosecution history of the patent application. The prosecution history is memorialized in various writings to create the U.S. Patent and Trademark Office (PTO) file history of the patent application or patent. As PTO communications are received, or responses or other communications filed with the PTO, these patent activities are docketed in a patent management system to track due dates, and corresponding documents and communications are uploaded into the patent management system.

The systems and methods set forth in this specification are described in relation to a patent management system (such as a patent docketing system) and patent matters, but it will be understood that the present invention could equally be applied to other forms of intellectual property (trademarks, copyright, registered designs, and the like). Moreover, the term “patent” is not intended to be limited to an issued patent, but may include a pending patent application or unfiled application or invention disclosure. The term “user” is intended to cover any person interacting with the patent management system. A user may be an inventor, portfolio manager, business manager, patent attorney, patent paralegal, or patent docketing personnel, for example.

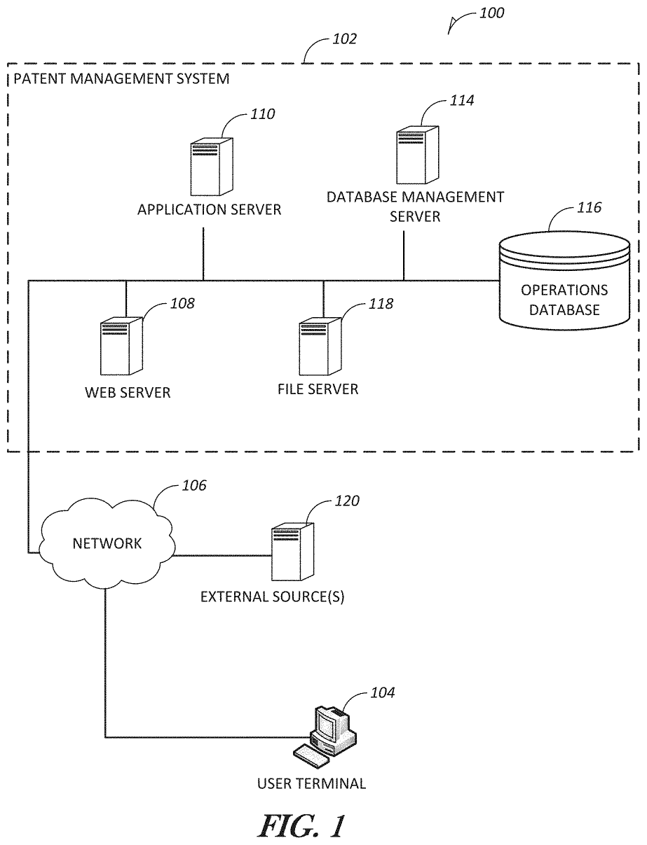

FIG. 1 is a schematic view of computer network system 100 according to various embodiments. The computer network system 100 includes patent management system 102 and user terminal 104 communicatively coupled via network 106. In an embodiment, patent management system 102 includes web server 108, application server 110, and database management server 114 which may be used to manage at least operations database 116 and file server 118. Patent management system 102 may be implemented as a distributed system, for example one or more elements of the patent management system 102 may be located across a wide-area network (WAN) from other elements of patent management system 102. As another example, a server (e.g., web server 108, file server 118, database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based applications and presentation of information. For example, application server 110 may consist of scripts, applications, or library files that provide primary or auxiliary functionality to web server 108 (e.g., multimedia, file transfer, or dynamic interface functions). Applications may include code, which when executed by one or more processors, run the software components of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in patent management system 102, may provide a user-interface to user terminal 104 for interacting with the tools of patent management system 102 stored in application server 110. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 104 may be a personal computer or mobile device. In an embodiment, user terminal 104 includes a client program to interface with patent management system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a compilation, represent an “operations database.” Sub-databases in such a configuration may include a matter database a portfolio database, a user database, a mapping database and an analytics database. Operations database 116 may be implemented as a relational database, a centralized database, a distributed database, an object oriented database, or a flat database in various embodiments.

In various embodiments, the patent management system framework may have a base organization unit of a matter. In various embodiments, a matter is an issued patent or patent application that includes one or more patent claims. In an embodiment, a matter is generally identified by its patent number or publication number. Identification may mean either identification as it relates to a user of the patent management system or within the patent management system. Thus, a user may see a matter listed as its patent number while internally a database of the patent management system may identify it by a random number.

One or more matters may be grouped together to form a portfolio. A matter may also be associated with one or more other matters in a family. A family member may be a priority matter, a continuing (e.g., continuation, divisional) matter, or foreign counter-part member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various embodiments, a matter may be associated with more than one portfolio by creating multiple entries in the portfolio database, one for each portfolio that the matter is associated with. In other embodiments, one or more patent reference documents may be associated with a patent by creating multiple entries in the patent database, for example. The structure of the database and format and data field titles are for illustration purposes and other structures, names, or formats may be used. Additionally, further associations between data stored in the databases may be created as discussed further herein.

During operation of patent management system 102, data from multiple data sources (internal and external) may be imported into or accessed by the operations database 116. Internal sources may include data from the various tools of the patent management system. External sources 120 may include websites or databases associated with foreign and domestic patent offices, assignment databases, WIPO, and INPADOC. In various embodiments, the data is scraped and parsed from the websites. The data may be gathered using API calls to the sources when available. The data may be imported and stored in the operations database on a scheduled basis, such as daily, weekly, monthly, quarterly, or some other regular or periodic interval. Alternatively, the data may be imported on-demand. The imported data may relate to any information pertaining to patents or patent applications, such as serial numbers, title, cited art, inventor or assignee details and the like.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats).

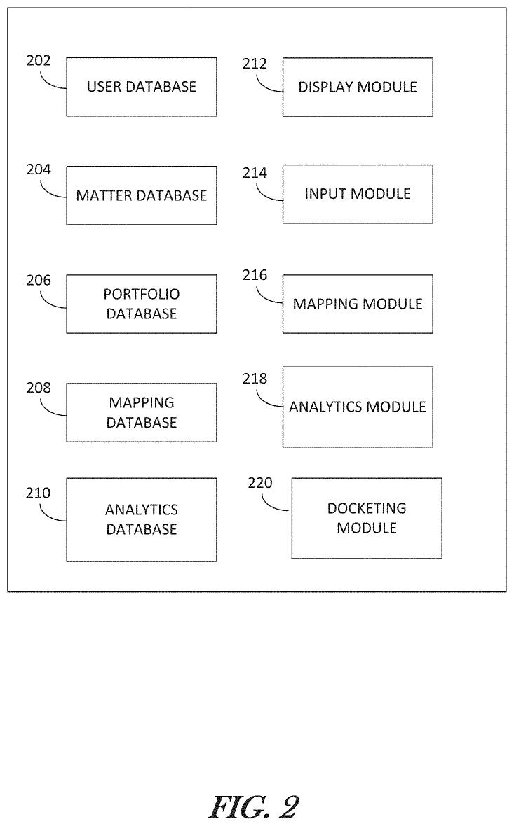

FIG. 2 is a block diagram of patent management system 102, according to an example embodiment. Illustrated are user database 202, matter database 204, portfolio database 206, mapping database 208, analytics database 210, display module 212, input module 214, mapping module 216, analytics module 218, and docketing module 220. In various embodiments, the data stored in databases 202, 204, 206, 208, and 210 may be in the same or multiple physical locations. For example, portfolio database 206 may be stored in one or more computers associated with a portfolio management service. In various embodiments, patent management system 102 mirrors databases stored in other locations. In an embodiment, when a request is made to access data stored in the databases, patent management system 102 determines where the data is located and directs the request to the appropriate location. Similarly, modules 212-220 may be executed across multiple computer systems.

In an embodiment, matter database 204 stores data representing matters as well as file histories, correspondences, and other documents related to patent matters. Each matter may be associated with one or more portfolios. In some embodiments, a matter is associated with no portfolios. In various embodiments, a matter is a foreign or domestic patent or application. Matters may also be inventions that have not yet been filed. In an embodiment, a matter entry includes data fields representing a matter ID, patent number, publication number, serial number, docketing number, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, inventors of the matter, current owner of the matter, cited references on the face of the matter, filed date, issue date, docket number, and annuity information (e.g., due date, country, and amount due).

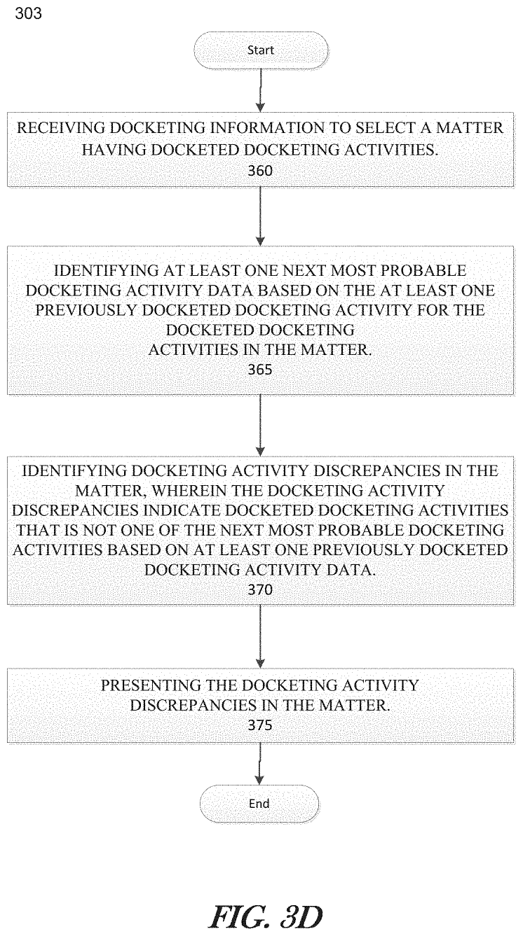

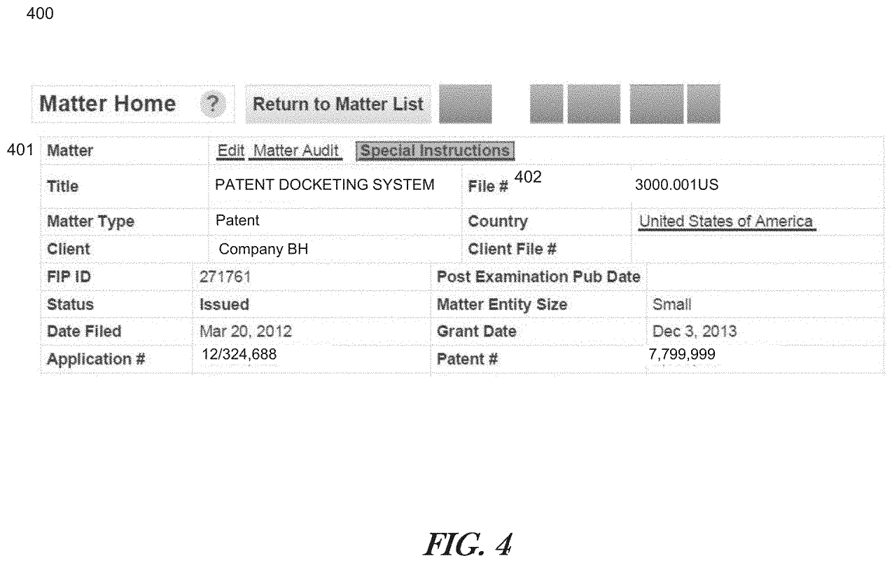

More or fewer data fields associated with a patent may be included in a matter entry stored in matter database 204. In an example embodiment, matter database 204 may store a patent matter database, wherein this database includes patent matter data and related documents and communications. FIG. 4 illustrates an example matter in patent management system 102. In some embodiments, other patent reference documents or prior art in any form may be stored and associated with one or more matters.

For an example embodiment, a complete list of docketing activity templates is stored in a table in matter database 204 and/or analytics database 210. The docketing activity table may include at least one record for each docketing activity. The database records for the docketing activities include docketing activity template information and the next most probable docketing activities and/or templates information corresponding to the docketing activity. The next most probable docketing activities may be entered into fields in the corresponding docketing activity record. The activities included in the list of the next most probable docketing activities may be based on the probability that a particular activity may be the next activity docketed. The probability data for the next most probable docketing activities may be entered as fields into the records for the relevant docketing activities. The data to determine the probability that a particular activity may be the next activity docketed may be based on all, or a subset of, data available for all matters in the patent management system 102 and/or data available from one or more external patent management systems, and this data may be updated after docketing activities in the patent management system 102. As such, the probability data for the next activity to be docketed may evolve naturally.

In various embodiments, the data is scraped and parsed from the websites if it is unavailable through a database. The data may be gathered using API calls to the sources when available. The data may be imported and stored in the operations database on a scheduled basis, such as daily, weekly, monthly, quarterly, or some other regular or periodic interval. Alternatively, the data may be imported on-demand. The imported data may relate to any information pertaining to patents or patent applications, such as serial numbers, title, cited art, inventor or assignee details and the like.

In various embodiments, a matter is associated with one or more other matters as a family with a family ID. Family members may be priority documents, continuation patents/applications, divisional patents/applications, and foreign patent/application counterparts. In an embodiment, family information is determined according to an external source such as INPADOC. Patent reference documents and/or other prior art may be manually or automatically stored, cross-cited and associated with related family matters, for example.

Portfolio database 206, in an example embodiment, stores data representing portfolios of one or more matters. Data stored in portfolio database 206 may have been previously generated the patent management system 102. In various embodiments, a portfolio may be generated by a user using patent management system 102. For example, a user interface may be presented to the user requesting a name for the portfolio and identifiers of matters to be included in the portfolio. In an embodiment, a portfolio entry in portfolio database 206 includes the data fields of portfolio ID and portfolio name. Additionally, a data field for matter ID may also be included in an entry in the portfolio database. Thus, each portfolio may be associated with one or more matters through the use of the matter ID data field. More or fewer data fields associated with a portfolio may be included in a portfolio entry of portfolio database 206.

For various embodiments, a portfolio may represent all matters associated with a particular law firm, client, technology or other grouping of matters. By grouping portfolios in this manner, the docketing processes for docketing the next most probable docketing activity may be customized or tailored for a particular client or law firm. For example, a law firm managing portfolios of several clients, may decide to tailor their docketing process flows for the individual clients based on the client's internal intellectual property procedures. This may require the law firm to add customized docketing activity templates to track non-PTO activities.

In various embodiments, mapping database 208 may include mappings of patent concepts to one or more matters. For example, the mapping module 216 is configured to facilitate mappings to associate at least one response due date or other date (e.g., date mailed) with the at least one downloaded document.

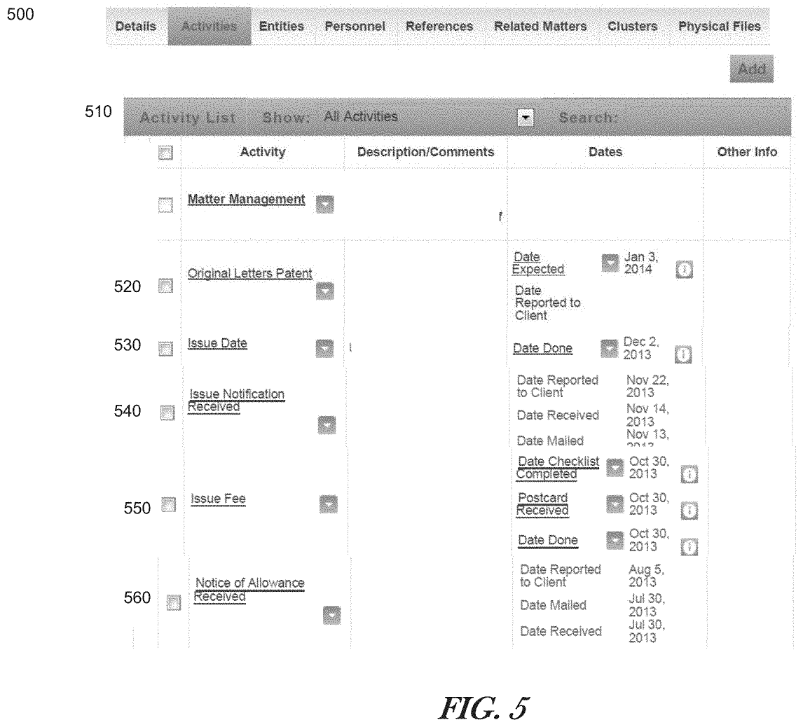

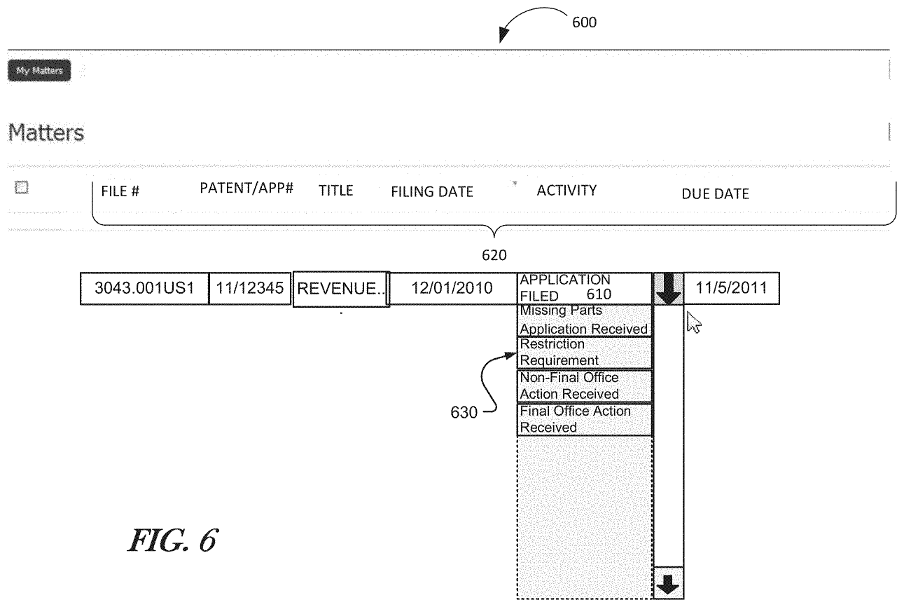

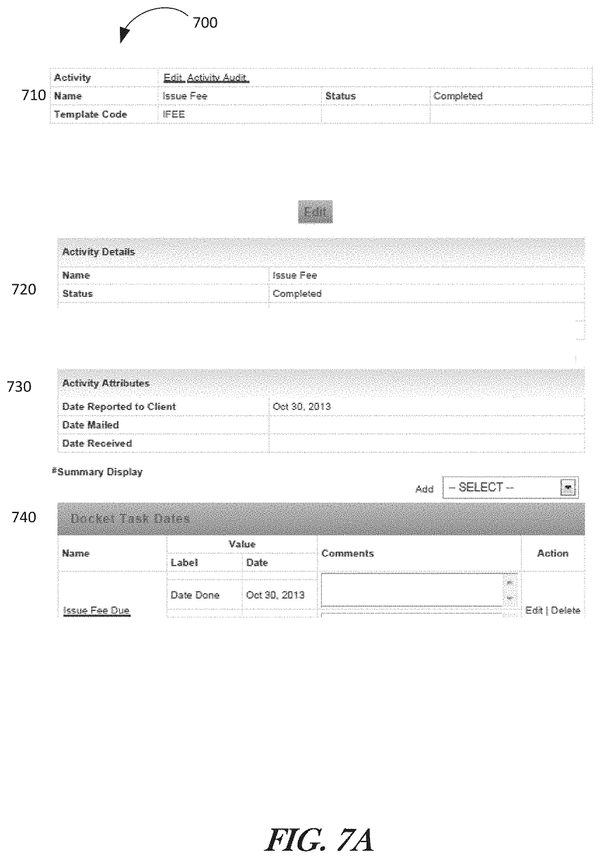

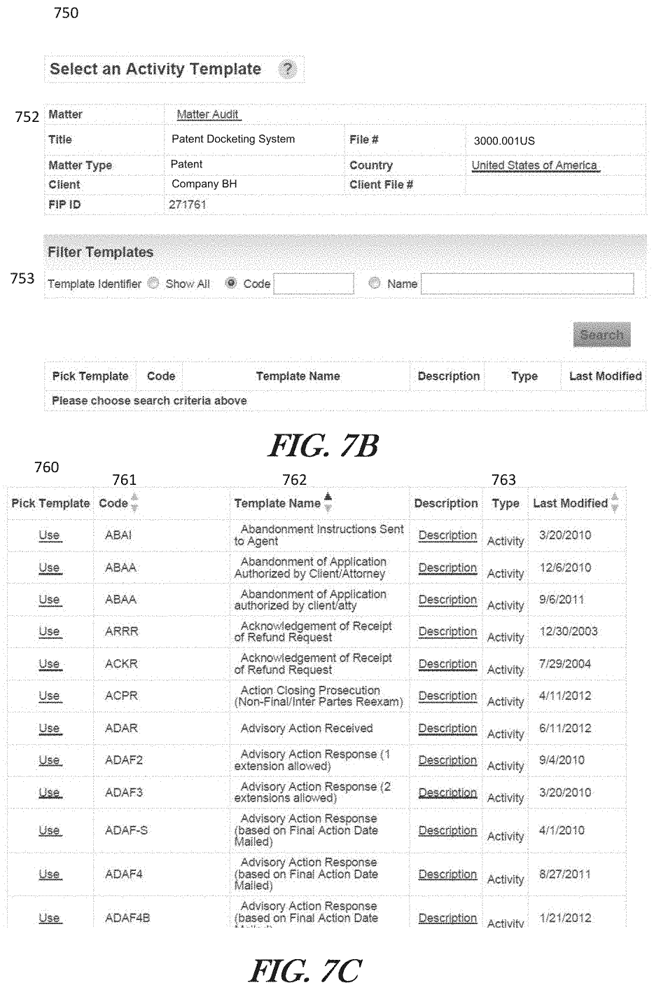

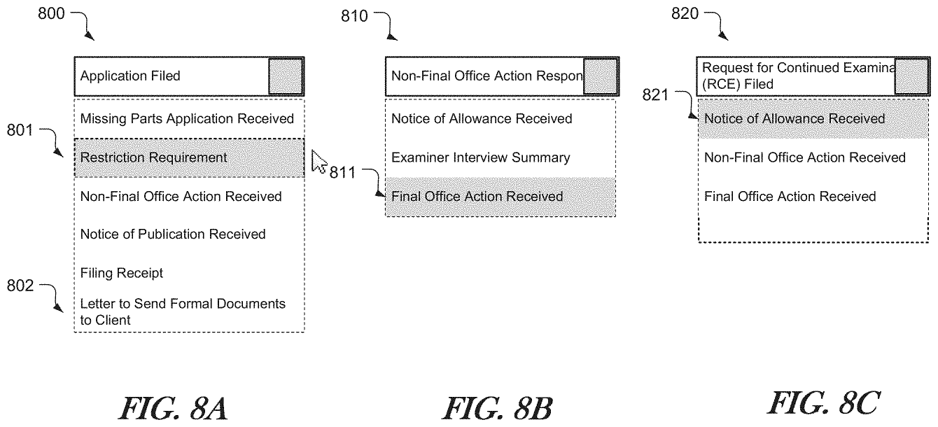

In an embodiment, display module 212 is configured to display user interfaces and information retrieved from one or more databases 202-210. If a user is accessing patent management system 102 remotely (e.g., through a web browser), display module 212, representing a user-interface through a network to a user terminal, may be configured to transmit data. In various embodiments, display module 212 may present patent matters details, as shown in FIG. 4; various docketing activities docketed including relevant dates for patent matters, as shown in FIG. 5; a pull-down menu displaying the next most probable docketing activities for a patent matter, as shown in FIG. 6; a patent docketing activity template corresponding to a patent activity, as shown in FIG. 7A, a fields for selecting a patent docketing activity template, as shown in FIG. 7B; a partial list of patent docketing activity templates available for docketing patent activities in patent matter, as shown in FIG. 7C; and lists for the next most probable docketing activities based on the last previously docketed docketing activity data in a matter, as shown in FIGS. 8A-C. Furthermore, data may be entered, through input module 214, into the user interface fields shown in FIGS. 4-8.

In various embodiments, input module 214 receives data from multiple sources where it may be further processed by one or more other modules and stored in one or more of databases 202-210. In various embodiments, input module 214 of the patent management system 102 may comprise a search engine (not shown) for conducting searches at a patent registry or on the Internet. For example, input module 214 may be configured to utilize one or more APIs to data from one or more patent data stores (e.g., public PAIR, private PAIR, INPADOC, foreign patent offices, patent docketing systems, portfolio management systems, etc.). The data may include published patent documents, patent applications, office actions or other patent office correspondences, prior art references, dockets dates, annuity payment data and patent or patent application assignment information. Specific assignment data may include details pertaining to the assignor or assignee (e.g. name, address, nationality, place of incorporation), date of assignment, details of the matter being assigned, or any other data pertaining to assignments or change in ownership that may be recorded at any national or regional patent registry such as the United States Patent and Trademark Office (USPTO), World Intellectual Property Organization (WIPO) or European Patent Office (EPO), for example.

In various embodiments, input module 214 is configured to receive input from one or more user interface elements. For example patent management system 102 may present multiple user interfaces to a user. These user interfaces may enable users to input data directly into databases 202-210, instruct the patent management system to retrieve data from patent data stores, and instruct the patent management system to perform various operations (e.g., analysis) on the data in databases 202-210.

Additionally, input module 214 may be configured to determine the selection of one or more user interface elements by a user and initiate the action associated with the selected user interface element. For example, a user interface element may include a drop-down menu to select a portfolio or a next most probable docketing activity. Input module 214 may be configured to receive the selection of the portfolio or next most probable docketing activity by the user. Then, input module 214 may pass the selection to one or more other modules for further processing. For example, display module 212 may update the drop-down menu to indicate the selection of the portfolio or the selection of the next most probable docketing activity. In other example embodiments, input module 214 may be configured to receive user input to select patent matters and patent activity templates for docketing, and then provide the necessary information to update the patent activity templates to generate the docket due dates or other due dates to implement the user's patent management workflows.

In various embodiments, input module 214 processes the data that has been inputted and formats it according to the data fields of databases 202-210 as discussed above. In various embodiments processing is completed using a parsing module (not shown). For example, consider a patent publication that a user has directed to be inputted into one or more of the databases. The parsing module may use a combination of automatic image recognition and text analysis to determine the filing date, issue date, title, abstract, and claims of the patent. In some embodiments, the parsing module may flag certain pieces of data that had been determined to be potentially inaccurate (e.g., a number could not be read). A user of patent management system 102 may then examine the flagged data and manually enter the information which is then stored in the appropriate database.

The resulting data that has been parsed by the parsing module may then be entered as an entry in one or more of databases 202-210. This may be accomplished by, for example, formulating an insert SQL query with the parsed information. In various embodiments the parsing module may parse multiple pieces of information before generating a database entry. For example, input module 214 may receive a docket number for an issued patent. The docket number may be combined with the information parsed from the issued patent to form an entry in matter database 204.

In various embodiments, analytics module 218 is configured to examine and run calculations on the data stored in the databases 202-210 to generate the most probably next docketing activity. In an embodiment, the queries are formulated and run as requested by a user. In an embodiment, once the analytics information has been determined, it is stored within analytics database 210. In various embodiments, queries are formulated and run on a periodic basis (e.g., nightly) and entries in analytics database 210 may be updated to reflect any changes. In other embodiments, the analytics module 218 may in response to user input formulate a query to examine the next most probable docketing activity. For example embodiments, the next most probable docketing activity may be based on the last previously docketed docketing activity data or multiple previously docketed docketing activities for a particular patent matter.

In various embodiments, the docketing module 220 is configured to provide template-based docketing of activities for patent matters with country-law-based due date calculations and customizable workflows to automate docketing activities as needed. The docketing module 220 includes docketing activity templates for the various PTO activities and other templates for non-PTO activities for managing PTO and non-PTO due dates and activities, both of which can be pre-defined by the system or customized by users to implement the desired patent docketing workflows. Examples of non-PTO templates and docketing activities include the tracking of due dates for managing internal tasks within a law firm or corporate patent department, or tracking correspondences to-and-from foreign associates who are the registered agents for the patent matters in their respective PTO. FIG. 7C illustrates example docketing activity templates that may be used in patent management system 102.

Several key decisions such as filing international applications or filing divisionals/continuations/CIPs, and annuity payment review can be triggered directly from docketing module 220. The docketing module 220 calculates the deadlines based on filing, prosecution, and grant dates for each patent matter or other prosecution dates (e.g., date mailed, date received, etc.), jurisdiction and applicable laws and applicable, and type of filing. Furthermore, the docketing module 220 is updated with the applicable country laws for all major countries as needed. Additionally, the docketing module 220, together with display module 212 and input module 214, provides an interface for users to input docketing data required (including the selection of the next most probable docketing activity) for docketing and due date generation into the relevant fields.

Tracking statutory deadlines and storing PTO correspondences is critical for managing patent portfolios effectively. Several PTO offices provide electronic data access for filing, prosecution, and maintenance-related activities, which can be accessed by the docketing module 220 via input module 214, which may have an electronic interface, such as an API, for fully or partially automating the downloading of documents and correspondences from the PTOs and/or uploading and docketing in the user's patent management or docketing system. The PTO correspondences are stored in matter database 204 and can be retrieved thru input module 214 by the user.

Patent docketing systems may be maintained or updated automatically, as described above, or by patent docketing specialists who performs docketing and upload documents and correspondences into the patent management system 102 as PTO correspondences are received. Furthermore, the patent management system needs to be updated with information and docketing activities as patent attorneys, agents or paralegals complete patent activities, such as filing various responses with the U.S. PTO. The patent docketing process requires trained patent docketing specialists, who understand the patent lifecycle and PTO rules and regulations to properly docketed patent matters as responses or other documents are filed with the PTO, or received from the PTO, to docket PTO activities. Other non-PTO activities may also be important to docket, for example, law firms docket their internal processes for implementing their client requested procedures or correspondences with foreign associates who communicate and file responses directly with their respective foreign patent offices.

One of the challenges in accurate and timely docketing is to make sure the patent docketing specialists, or other data entry personnel, are selecting the correct docketing activity template and completing the template correctly such that the correct PTO deadline is generated when receiving documents and correspondences from the PTOs or patent attorneys or paralegals for docketing. By having the analytics module 218 generate a list of the next most probable docketing activities when docketing a new patent activity, the patent docketing specialist is less likely to use the wrong docketing activity template (and thereby generating an inaccurate due date). The analytics module 218 relies on the last previously docketed docketing activities for matters or multiple previously docketed docketing activities available from the matter file history. Presenting a list of the next most probable docketing activities helps to streamline the patent docketing process and reduces the likelihood of data entry docketing errors. The list may also be used during the docketing verification process to quickly assess whether docketing was done correctly and to flag activities which appear unlikely to be correct. This verification process can quickly identify low or no probability docketing activities were selected.

In various embodiments and with reference to FIG. 2, a docketing system for managing matters 102 may comprise an input module 214 configured to receive docketing information to select a matter for docketing; a docketing module 220 configured to access at least one previously docketed docketing activity data for the matter; an analytics module 218 configured to identify at least one next most probable docketing activity based on the at least one previously docketed docketing activity data for the matter; and a display module 212 configured to present the at least one next most probable docketing activity for the matter and to receive user input to select a docketing activity from at least one next most probable docketing activity for the matter.

Further embodiment of a docketing system include an input module 214 configured to receive user input to select a docketing activity template corresponding to the user selected docketing activity from the at least one next most probable docketing activity for the matter and to receive user input to update the docketing activity template with at least one date.

Additional embodiments of a docketing system include a docketing module configured to calculate at least one response due date for the user selected docketing activity based on the at least one date and to present to the user the docketing activity and the at least one response due date.

In some embodiments, a patent management system comprises a network 106; at least one patent database (operations database 116, sub-databases 202-210, or external source database at USPTO PAIR, for example), accessible on the network, and storing data including docketing activity data of at least one matter stored in the patent database, and a server (any one of 110-118), operatively connected to the network, wherein the server includes a processor, a memory, software operable on the processor to receive docketing information to a matter for docketing; access at least one previously docketed docketing activity data for the matter from the at least one patent database; and identify at least one next most probable docketing activity based on the at least one previously docketed docketing activity data for the matter.

In other embodiments, the software is operable on the processor to present the at least one next most probable docketing activity for the matter; receive user input to select a docketing activity from the presented at least one next most probable docketing activity for the matter; receive user input to select a docketing activity template corresponding to the user selected docketing activity from the presented at least one next most probable docketing activity for the matter; receive user input to update the docketing activity template with at least one date; calculate at least one response due date for the user selected docketing activity based on the at least one date; and present the docketing activity and the at least one response due date.

In further embodiments, the software is operable on the processor to select a docketing activity from the at least one next most probable docketing activity and a corresponding docketing activity template to docket the docketing information for the matter; update the docketing activity template with at least one date; calculate at least one response due date based on the least one date; and store the at least one due date for the user selected docketing activity for the patent matter.

In some embodiments, a patent management system comprises a network 106; at least one patent database (operations database 116, sub-databases 202-210, or external source database at USPTO PAIR, for example), accessible on the network, and storing data including docketing activity data of at least one patent matter stored in the database, and a server (any one of 110-118), operatively connected to the network, wherein the server includes a processor, a memory, software operable on the processor to receiving docketing information to select a matter having docketed docketing activities; identify at least one next most probable docketing activity based on the at least one previously docketed docketing activity data for the docketed docketing activities in the matter; and identify docketing activity discrepancies in the matter, wherein the docketing activity discrepancies indicate docketed docketing activities that are not one of the next most probable docketing activities based on at least one previously docketed docketing activity data.

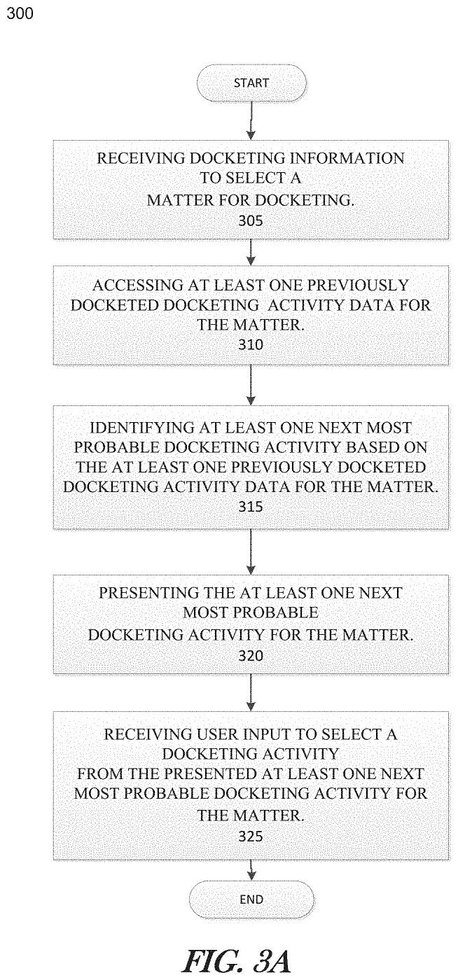

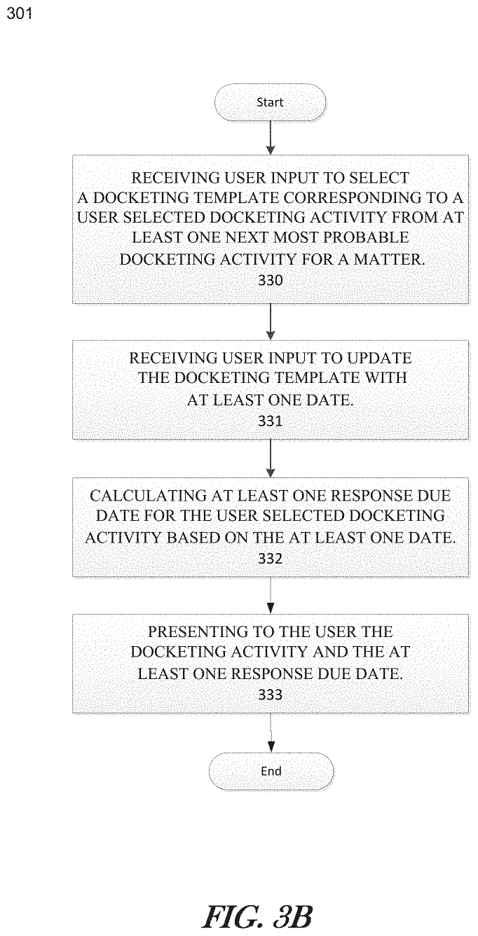

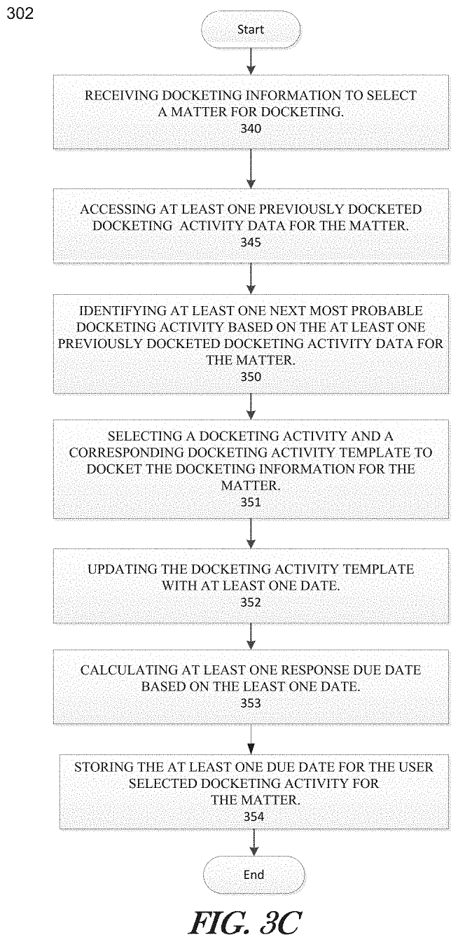

Some embodiments of the present inventive subject matter include methods for aspects of patent management. Block diagrams of such methods are shown in FIGS. 3A-3D.

FIG. 3A illustrates a method of docketing based on the next most probable docketing activities, according to an example embodiment. A method 300 for docketing matters comprises: at block 305, receiving docketing information to select a matter for docketing; at block 310, accessing at least one previously docketed docketing activity data for the matter; at block 315, identifying at least one next most probable docketing activity based on the at least one previously docketed docketing activity data for the matter; at block 320, presenting the at least one next most probable docketing activity for the matter; at block 325, receiving user input to select a docketing activity from the presented at least one next most probable docketing activity for the matter.

FIG. 3B illustrates a method of docketing based on next most probable docketing activities, according to one embodiment. A method 301 for docketing matters comprises: at block 330, receiving user input to select a docketing activity template corresponding to the user selected docketing activity from the at least one next most probable docketing activity for the matter; at block 331, receiving user input to update the docketing activity template with at least one date; at block 332, calculating at least one response due date for the user selected docketing activity based on the at least one date; and at block 333, presenting to the user the docketing activity and the at least one response due date.

FIG. 3C illustrates a method of docketing based on the next most probable docketing activities, according to another example embodiment. A method 302 for docketing matters comprises: at block 340, receiving docketing information to select a matter for docketing; at block 345, accessing at least one previously docketed docketing activity data for the matter; at block 350, identifying at least one next most probable docketing activity based on the at least one previously docketed docketing activity data for the matter; at block 351, selecting a docketing activity from the at least one next most probable docketing activity and a corresponding docketing activity template to docket the docketing information for the matter; at block 352, updating the docketing activity template with at least one date; at block 353 calculating at least one response due date based on the least one date; at block 354, storing the at least one due date for the user selected docketing activity for the matter.

FIG. 3D illustrates a method of verifying docketing activities based on the next most probable docketing activities, according to another example embodiment. A method 303 for verifying docketing activities comprises: at block 360, receiving docketing information to select a matter having docketed docketing activities; at block 365, identifying at least one next most probable docketing activity based on the at least one previously docketed docketing activity data for the docketed docketing activities in the matter; at block 370, identifying docketing activity discrepancies in the matter, wherein the docketing activity discrepancies indicate docketed docketing activities that are not one of the next most probable docketing activities based on at least one previously docketed docketing activity data; and at block 375, presenting the docketing activity discrepancies in the matter.

Reference is now made to FIGS. 4-8, which show user interfaces that may be used to present patent information to the user in the patent management system 102, according to example embodiments. The user interfaces may be displayed by display module 212 as described above. The user interface may be provided in a website, computer monitor, or mobile device. The type of user elements, names, and layout depicted in FIGS. 4-8 are intended to be an illustration of an example user interface of patent management system 102. Other types of user elements, names, and layouts may be used.

User interfaces illustrated in FIGS. 4-8 include multiple user interface elements. In an example embodiment, a user interface element is a graphical or textual element that a user may interact with to cause an application to perform an assigned action for the interface element. Data representing the user interfaces illustrated in FIGS. 4-8 may be transmitted via network 106 and presented on a display of user terminal 104 through the use of a web browser. A user (e.g., patent docketing personnel, patent paralegal, etc.) may interact with the user interface elements of the user interface through the use of an input device (e.g., stylus, cursor, mouse, and a finger) of the user terminal. In an embodiment, a user selection is based on the coordinates of the input device as it makes contact with the display or where a user “clicks” the mouse. The coordinates are compared to the coordinates of the user input element to determine the selection. The type of user elements, names, and layout depicted in FIGS. 4-8 are intended to be an illustration of an example user interface of patent management system 102. Other types of user elements, names, and layouts may be used. Some elements may be omitted in various embodiments depending on the nature of management tool provided.

FIG. 4 illustrates a user interface 400 for presenting patent matter details of a matter, according to an example embodiment. The user interface 400 represents a matter having various fields. The matter shown in user interface 400 has a Title field 401 representing the title of the matter and a File # field 402 representing the file number of the matter. Although the File # is the most common way to select a matter in user interface 400, other fields such as Title, Patent #, etc. can be used to select a matter for docketing. Various other matter detail fields are shown by user interface 400 such as the Matter Type, Country, Client, Client File #, Status, Matter Entity Size, Date Filed, Grant Date, Application # and Patent #. The matter detail fields may be referred to as docketing information.

FIG. 5 illustrates a user interface 500 for presenting docketing activities in a patent matter. As shown by user interface 500, the activities tab is selected, which provides a list of activities 510 for a patent matter. The following are patent docketing activities: Original Letters Patent 520, Issue Date 530; Issue Notification Received 540; Issue Fee 550; and Notice of Allowance Received 560. Each of the docketing activities listed below has a one or more corresponding dates. The docketing activities, Notice of Allowance Received 560 and Issue Notification Received 540 represent correspondences received from the U.S. PTO with corresponding due dates. The docketing activity Issue Fee 550 represents an action required by a user, such as a patent owner or legal representative of the patent owner. Each of the docketing activities 520, 530, 540, 550 and 560 has a corresponding docketing activity template (not shown).

FIG. 6 illustrates a user interface 600 for presenting a pull-down menu 630 with options representing the next most probable docketing activities based on a previously docketed docketing activity 610 for a patent matter, according to an example embodiment. Although user interface 600 shows a single docketing activity was used to determine the next most probable docketing activities, other embodiments may determine the most probable next activities based on the entire file history docketed for the matter or a portion of the file history docketed the matter. Various patent matter detail fields are shown in user interface 600. The pull-down menu illustrates four next most probable docketing activities (Missing Parts Applications Received, Restriction Requirement, Non-Final Office Action Received, and Final Office Action Received) for a previously docketed docketing activity 610 indicated by Applications Filed.

For the example shown by user interface 600, all four of the next most probable docketing activities, represent correspondences and documents received from the U.S. PTO. For the embodiment shown by user interface 600, a user displays the pull-down menu by highlighting the down arrow to view the options for the next most probable docketing activities. The options for the next most probable docketing activities is analysed by analytics modules 218 and presented by display module 212. One or more of the pull-down menu options may be pre-defined by the patent management system 102 or added by the user to customize the options to implement the user's workflows, procedures and/or processes.

Once a document or correspondence is received by the patent document system 102 or user, the docketing may be automated (at least to some extent) and performed manually. If the patent management system is docketed in an automated fashion, patent data and/or patent correspondences and documents is obtained by scraping pair (or other electronic data retrieval method). Next patent matter data (to identify the relevant matter) is parsed or otherwise extracted from an external database and/or correspondences and documents. Additionally, the analytics module identifies one or more previously docketed docketing activities for that matter (and accesses that data for the previously docketed docketing activity) to determine the next most probable docketing activities and presents those options to a user thru a pull-down menu or other types of views. The data for the previously docketed docketing activity is stored in a table in the matter database 204 and/or the analytics database 210 according to an example embodiment. Alternatively, docketing may be performed manually, at least in part, requiring a user, such as a patent docketing specialist to docket the relevant activity.

FIG. 7A illustrates a user interface 700 for presenting a docketing activity template, according to an example embodiment. Generally, the fields that are required (or optional) to be completed to create or update a docketing activity template may be referred to as docketing activity data, which is received by the patent management system 102 through input module 214 and is stored in database 116. The activity template 710 includes an activity name “Issue Fee” and a corresponding template code “IFEE”. The issue fee activity shown in the user interface 700 indicates a “completed” status with the issue fee paid at the U.S. PTO on the 10/30/13, as specified by the date done field. During docketing, docketing activity templates display activity details 720, the activity attributes 730 and/or docket task dates 740. The docket task dates 740 refer to PTO related deadlines. Other non-docket task dates may also be added or included in an activity template and referred to non-PTO related deadlines. An example of non-PTO deadlines includes responding to a letter from a foreign associate indicating an upcoming deadline to file a response in a foreign PTO. Various fields of the docketing activity template are updated during docketing either by a user or automatically, and various fields are auto-generated based on fields updated during docketing.

FIG. 7B illustrates a user interface 750 for selecting a docketing activity template within a patent matter, according to example embodiments. The patent matter details 752 are shown by the following matter fields labelled Title, File #, Matter Type, Country, Client, Client File # and FIP ID, which is the internal system tracking ID number for a matter. During docketing, docketing activity templates are retrieved from a database, such as database 116, by either specifying the docketing activity name or docketing activity template code via a user interface 750. The docketing activity name and/or template code can be entered and/or selected from user interface elements 753. If the exact docketing activity name and/or template code is not known, the user can filter on partial names and/or template codes with the Search button. Manually docketing information into docketing activities is generally performed through the docketing activity templates.

FIG. 7C illustrates a partial list 760 of docketing activity template names and template codes for patent management system 102, according to an example embodiment. The column 761 lists the template codes, the column 762 lists the corresponding template names, and the column 763 lists the corresponding template type 763. The template type 763 indicates that all the docketing activity templates included in the partial list 760 are activity docketing activity templates. For an example embodiment, a complete list of docketing activity templates, and associated data, is stored in a table in matter database 204 and/or analytics database 210. The docketing activity data may include matter detail fields, template fields, 760-763, matter activity fields and associated due dates, and activities identified as one of the next most probable docketing activities and associated probabilities.

FIGS. 8A-8C illustrate examples of the next most probable docketing activities based on the last docketing activity docketed in a patent matter. In FIG. 8A, the docketing activity Application Filed docketing activity 800 is the last previously docketed docketing activity docketed in a patent matter. Six next most probable docketing activities are presented to the user based on the last previously docketed docketing activity docketed. The docketing activity Restriction Requirement 801 is selected by the user from the list of the next most probable docketing activities to docket the next docketing matter in that patent matter.

The first five items on the list of next most probable docketing activity represents communications and documents from the U.S. PTO and is considered a PTO docketing activities. The docketing activities Missing Parts Application Received, Restriction Requirement, and Non-Final Office Action Received all require docketing due dates, which are typically auto-generated by docketing module 220 based on inputting another date, such as the date mailed. The docketing activity filing receipt is auto-generated by docketing module 220 when the Application Filed docketing activity 800 is docketed, but is completed by the user when the filing receipt is received by the user. The docketing activity Letter to Send Formal Documents to Clients is auto-generated by the patent management system if the Application Filed is not filed with a declaration. Since the docketing activity Letter to Send Formal Documents to Clients is not based on a PTO correspondence, it is considered a non-PTO docketing activity.

In FIG. 8B, the Non-Final Office Action Response docketing activity 810 represents the last previously docketed docketing activity in a patent matter. The user selects the Final Office Received docketing activity 811 to docket from a list of the three next most probable docketing activities.

In FIG. 8C, the Request for Continued Examination (RCE) docketing activity represents the last previously docketed docketing activity in a patent matter. The user selects the Notice of Allowance Received docketing activity 821 from a list of the three next most probable docketing activities.

The lists of the next most probable docketing activities shown in FIGS. 8A-8C may be displayed in the order of the activities with the highest probability to the lowest probability of the options on the next most probable docketing activity list, as determined by the analytics module 218 in an example embodiment. In an alternative embodiment, the options on the list are listed in a different order, for example, alphabetically or randomly. The lists of the next most probable docketing activities may include PTO docketing activities and/or non-PTO docketing activities, U.S. docketing activities and/or non-U.S. docketing activities (e.g., foreign docketing activities). Furthermore, the docketing activities may be template-based activities or non-template based activities. Additionally, the one or more options for the next most probable docketing activities may be presented to the user in a list, such as in a pull-down menu, or presented in some other fashion to the user.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

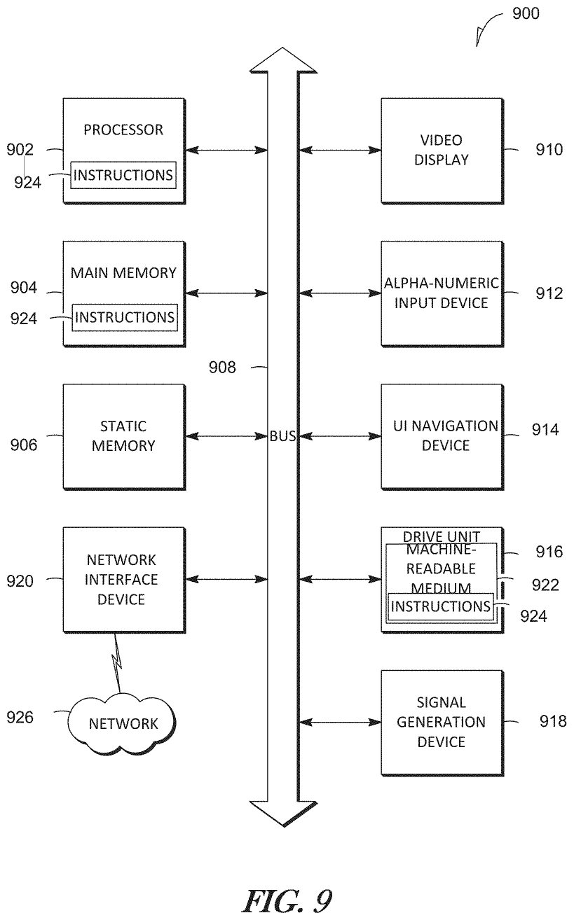

FIG. 9 is a block diagram of machine in the example form of a computer system 900 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top block (STB), a PDA, a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918 (e.g., a speaker) and a network interface device 920.

### Machine-Readable Medium

The disk drive unit 916 includes a machine-readable medium 922 on which is stored one or more sets of instructions and data structures (e.g., software) 924 embodying or utilized by any one or more of the methodologies or functions described herein. The instructions 924 may also reside, completely or at least partially, within the main memory 904 and/or within the processor 902 during execution thereof by the computer system 900, with the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 924 may further be transmitted or received over a communications network 926 using a transmission medium. The instructions 924 may be transmitted using the network interface device 920 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### Note on the Abstract

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. (canceled)

2. A method of docketing patent matters in a patent management system, the method comprising:
receiving docketing information to select a matter for docketing, wherein a client is associated with the matter;
accessing at least one previously docketed docketing activity data for the matter; and
identifying at least one next most probable docketing activity based on a set of docketing activity probability data, the set of docketing activity probability data including the at least one previously docketed docketing activity data for the matter, a set of docketing activity data of the patent management system, and a set of docketing activity data of an external patent management system;
accessing, from a template database, a customized docketing activity template based on the client associated with the matter, wherein each template in the template database is automatically customized based on past docketing activity of a related client;
selecting a client customized next most probable docketing activity by applying the customized docketing activity template to the at least one next most probable docketing activity;
determining if the client customized next most probable docketing activity is present in the at least one previously docketed docketing activity data for the matter;
in response to determining the client customized next most probable docketing activity is present in the at least one previously docketed docketing activity data for the matter, generating an error message;
transmitting, to a client interface device, the client customized next most probable docketing activity and the error message; and
updating the set of docketing activity probability data based upon the selection from the at least one next most probable docketing activity.

3. The method of claim 2, further comprising:
presenting, via a user interface, the at least one next most probable docketing activity for the matter to a user; and
wherein obtaining a selection includes receiving user input to select a docketing activity from the presented at least one next most probable docketing activity for the matter from the user.

4. The method of claim 3, further comprising:
receiving user input to select a docketing activity template corresponding to the user selected docketing activity from the presented at least one next most probable docketing activity for the matter;
receiving user input to update the docketing activity template with at least one date;
calculating at least one response due date for the user selected docketing activity based on the at least one date; and
presenting to the user the docketing activity and the at least one response due date.

5. The method of claim 2, further comprising:
selecting a docketing activity from the at least one next most probable docketing activity and a corresponding docketing activity template to docket the docketing information for the matter;
updating the docketing activity template with at least one date;
calculating at least one response due date based on the least one date; and
storing the at least one response due date for the selected docketing activity for the matter.

6. The method of claim 2, wherein accessing the at least one previously docketed docketing activity data for the matter further comprises accessing a last previously docketed docketing activity data for the matter.

7. The method of claim 2, wherein identifying the at least one next most probable docketing activity further comprises identifying at least one next most probable PTO docketing activity.

8. The method of claim 2, wherein identifying the at least one most probably next docketing activity further comprises determining at least one next most probable non-PTO docketing activity.

9. The method of claim 2, wherein presenting the at least one next most probable docketing activity further comprises displaying a pull down menu with a list of the at least one next most probable docketing activity.

10. The method of claim 9, wherein receiving user input to select the docketing activity from the presented at least one next most probable docketing activity for the matter further comprises selecting the docketing activity from the pull down menu.

11. A patent management system comprising:
at least one patent database, accessible on a network, and storing data including docketing activity data for at least one matter stored in the database, and
a server, operatively connected to the network, wherein the server includes:
a processor, a memory, and software operable on the processor to:
receive docketing information to select a matter for docketing, wherein a client is associated with the matter;
access at least one previously docketed docketing activity data for the matter from the at least one patent database; and
identify at least one next most probable docketing activity based on a set of docketing activity probability data, the set of docketing activity probability data including the at least one previously docketed docketing activity data for the matter, a set of docketing activity data of the patent management system, and a set of docketing activity data of an external patent management system;
access, from a template database, a customized docketing activity template based on the client associated with the matter, wherein each template in the template database is automatically customized based on past docketing activity of a related client;
select a client customized next most probable docketing activity by applying the customized docketing activity template to the at least one next most probable docketing activity;
determine if the client customized next most probable docketing activity is present in the at least one previously docketed docketing activity data for the matter;
in response to the determination the client customized next most probable docketing activity is present in the at least one previously docketed docketing activity data for the matter, generating an error message;
transmit, to a client interface device, the client customized next most probable docketing activity and the error message; and
update the set of docketing activity probability data based upon the selection from the at least one next most probable docketing activity.

12. The system of claim 11, further including:
a user interface;
wherein the software is further operable on the processor to:
present, via the user interface, the at least one next most probable docketing activity for the matter; and
receive, via the user interface, user input to select a docketing activity from the presented at least one next most probable docketing activity for the matter.

13. The system of claim 12, wherein the software is further operable on the processor to:
receive, via the user interface, user input to select a docketing activity template corresponding to the user selected docketing activity from the presented at least one next most probable docketing activity for the matter;
receive, via the user interface, user input to update the docketing activity template with at least one date;
calculate at least one response due date for the user selected docketing activity based on the at least one date; and
present to the user the docketing activity and the at least one response due date.

14. The system of claim 11, wherein the software is further operable on the processor to:
select a docketing activity from the at least one next most probable docketing activity and a corresponding docketing activity template to docket the docketing information for the matter;
update the docketing activity template with at least one date;
calculate at least one response due date based on the least one date; and
store the at least one response due date for the selected docketing activity for the patent matter.

15. The system of claim 11, wherein the at least one previously docketed docketing activity data for the matter is a last previously docketed docketing activity data for the matter.

16. The system of claim 11, wherein the at least one next most probable docketing activity includes at least one PTO or non-PTO docketing activity.

17. A docketing system, comprising:
at least one processor; and
memory including instructions that, when executed by the at least one processor, cause the at least one processor to:
receive docketing information to select a matter for docketing, wherein a client is associated with the matter;
access from at least one previously docketed docketing activity data for the matter;
identify at least one next most probable docketing activity based on a set of docketing activity probability data, the set of docketing activity probability data including the at least one previously docketed docketing activity data for the matter, a set of docketing activity data of a patent management system, and a set of docketing activity data of an external patent management system;
access, from a template database, a customized docketing activity template based on the client associated with the matter, wherein each template in the template database is automatically customized based on past docketing activity of a related client;
select a client customized next most probable docketing activity by applying the customized docketing activity template to the at least one next most probable docketing activity;
determine if the client customized next most probable docketing activity is present in the at least one previously docketed docketing activity data for the matter;
in response to the determination that the client customized next most probable docketing activity is present in the at least one previously docketed docketing activity data for the matter, generating an error message;
transmit, to a client interface device, the client customized next most probable docketing activity and the error message; and
update the set of docketing activity probability data based upon the selection from the at least one next most probable docketing activity.

18. The docketing system of claim 17, further comprising instructions to receive user input to select a docketing activity template corresponding to the user selected docketing activity from the presented at least one next most probable docketing activity for the matter and to receive user input to update the docketing activity template with at least one date.

19. The docketing system of claim 18, further comprising instructions to:
calculate at least one response due date for the user selected docketing activity based on the at least one date; and
present to the user the docketing activity and the at least one response due date.

20. The docketing system of claim 18, further comprising instructions to:
select a docketing activity from the at least one next most probable docketing activity and a corresponding docketing activity template to docket the docketing information for the matter;
update the docketing activity template with at least one date;
calculate at least one response due date based on the least one date; and
store the at least one response due date for the selected docketing activity for the matter.

21. The docketing system of claim 18, wherein accessing the at least one previously docketed docketing activity data for the matter further comprises accessing a last previously docketed docketing activity data for the matter.
